(19) United States
(12) Patent Application Publication
(10) Pub. No.: US 2018/0359991 A1
(43) Pub. Date: Dec. 20, 2018

(54) Food Spread Holder for Animals

(71) Applicants: Gregg Myles Levin, Wellesley, MA (US); Guang Yu Gao, Malden, MA (US)

(72) Inventors: Gregg Myles Levin, Wellesley, MA (US); Guang Yu Gao, Malden, MA (US)

(21) Appl. No.: 16/009,262

(22) Filed: Jun. 15, 2018

Related U.S. Application Data
(60) Provisional application No. 62/612,347, filed on Dec. 30, 2017.

(51) Int. Cl. A01K 5/00

(52) U.S. Cl. CPC A01K 5/00

(57) ABSTRACT

A container arranged to function as a holder and support surface for a quantity of food spread to be consumed by an animal, such food spread comprising peanut butter or other edible substance having a similar paste like consistency, which container can be attached to a support surface in a variety of positions and angles from horizontal to upright.

### CROSS REFERENCE TO RELATED APPLICATIONS

This application is based on the disclosure of U.S. Provisional Application No. 62/612,347 filed Dec. 30, 2017 by the same inventors which disclosure is herein incorporated by reference.

### BACKGROUND OF THE INVENTION

### Field of the Invention

The invention resides in the field of food containers and more particularly relates to a food spread holder which is adapted to be attached to a surface at various positions and angular orientations from the horizontal to the upright or vertical.

### Description of the Prior Art

The inventors are unaware of any prior art devices which provide a structure having the novel features of the invention as herein disclosed which are suitable for holding or containing a food spread with the consistency of paste for the consumption of animals in a multiplicity of positions or dispositions from the horizontal to the upright or vertical.

The prior art does disclose animal traps employing bait attachment arrangements in vertical positions designed to attract and capture pests but lack any features providing for the consumption of such bait for the benefit of the animal. For example, U.S. Pat. No. 1,507,532, Vickers, discloses a rodent trap wherein a bait retaining means is disposed as to be freely in view of an animal but incapable of being reached by it. Similarly, U.S. Pat. No. 9,510,587, Hedel, shows a bait holder positioned to lure a rodent into an ensnarement apparatus activated by the proximity and weight of the animal.

In contrast, the invention disclosed herein is particularly adapted for the benefit of an animal by providing structural arrangements for the consumption of a food spread without harm to the creature.

### SUMMARY OF THE INVENTION

The invention may be summarized as a holder or container device for retaining a quantity of food spread with the consistency of a paste, peanut butter for example, attachable to a surface from which holder the food spread can be consumed by an animal, as for example, by licking by a dog. The bottom side of the holder may comprise a self-adhering surface as one example of an attachment arrangement. The top side may comprise one or more raised members or protrusions creating cups or crevices into which the food spread can be disposed.

The invention may be employed in a variety of ways such as, for example, a distraction device when bathing or grooming a pet, on a paddle as a reward device for dog training, or used as a birdfeeder. Further advantages and features of the invention will become more apparent from the description of the preferred embodiment and drawings which follow.

### DESCRIPTION OF THE FIGURES

FIG. 1 is a perspective view of a preferred embodiment of the invention;

FIG. 2 is a front view of the embodiment of FIG. 1;

FIG. 3 is a rear view of the embodiment of FIG. 1;

FIG. 4 is an elevation view of the embodiment of FIG. 1;

FIG. 5 is an illustration of the embodiment of FIG. 1 in use;

FIG. 6 is an additional illustration of the embodiment of FIG. 1 in use; and

FIG. 7 is a further illustration of the embodiment of FIG. 1 in use.

### DESCRIPTION OF THE PREFERRED EMBODIMENT

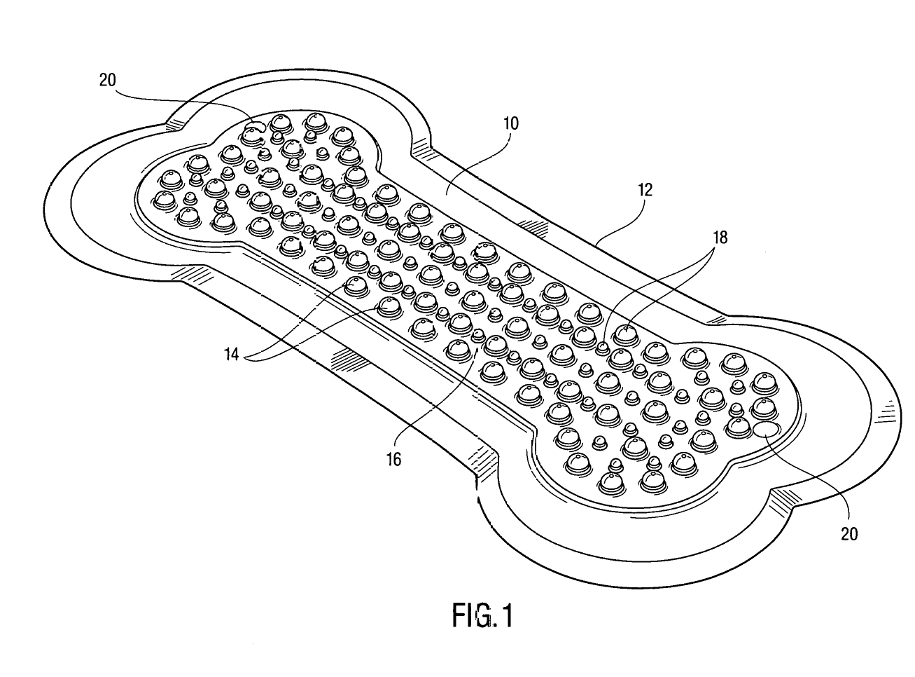

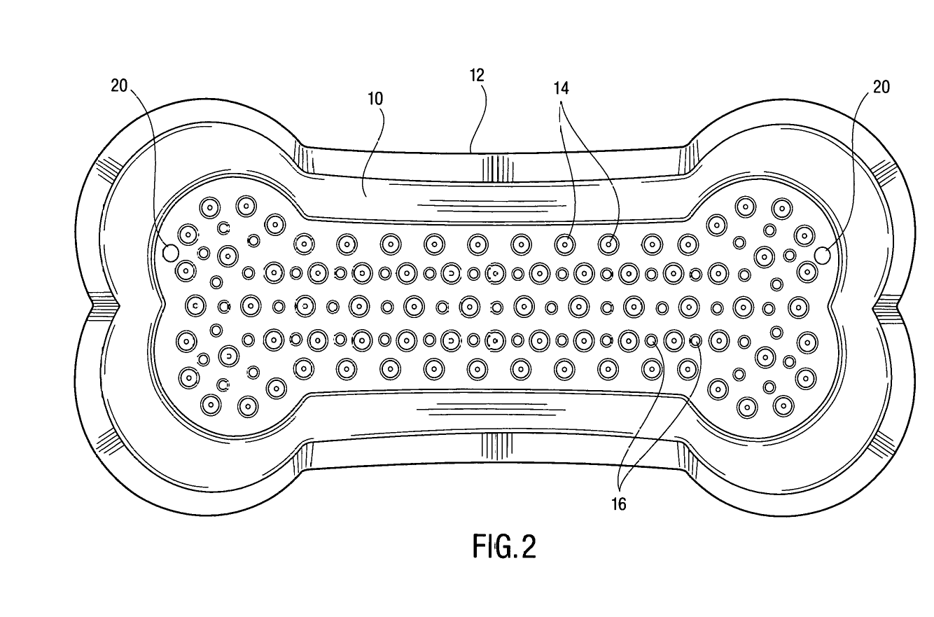

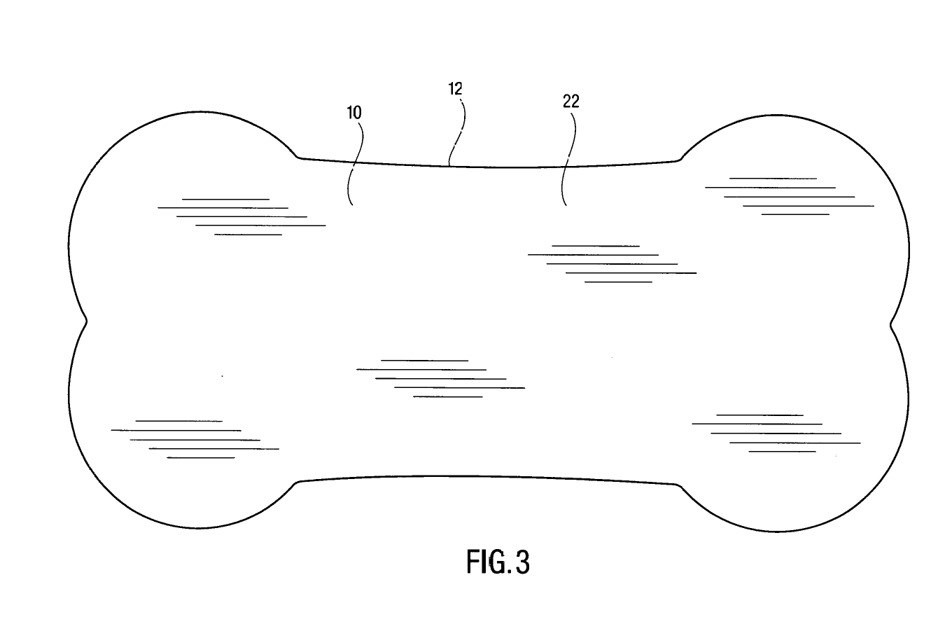

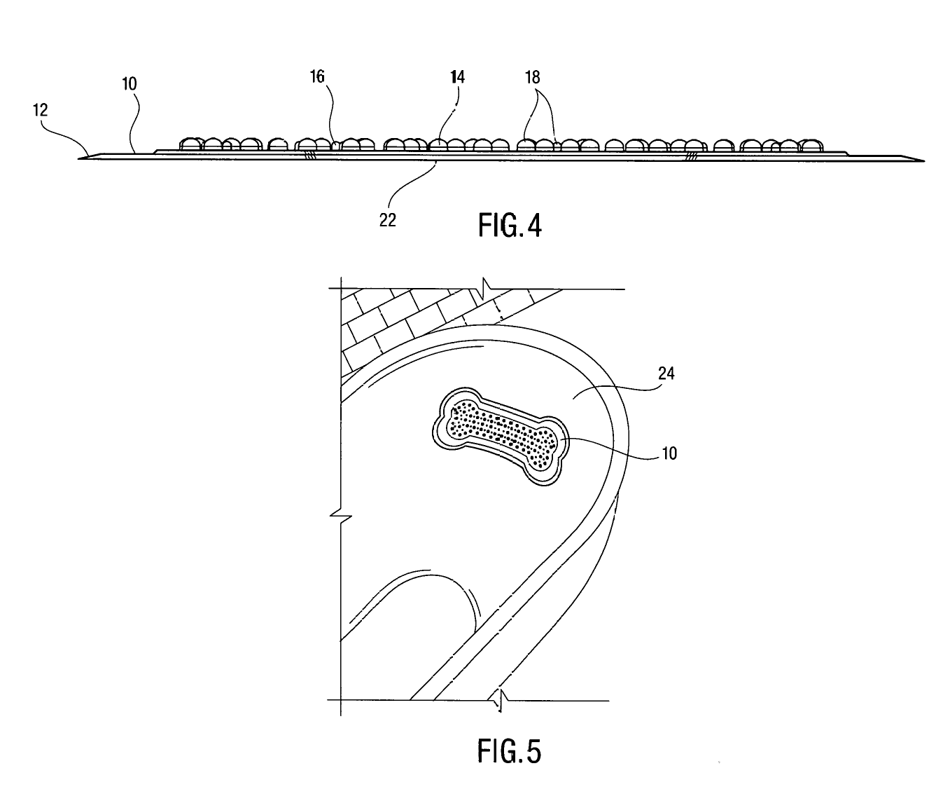

Referring to FIGS. 1 2, 3, and 4, the holder consists of a base 10 which is preferably flexible so as to conform to both planer and curved surfaces and which may be constructed of, for example, molded food grade silicon rubber. The periphery 12 is shown is in the shape of a stylized dog biscuit as an example but may be of any desirable shape.

A number of protrusions 14 and shorter 16 are disposed within the periphery extending substantially upright from the base which protrusions may be of uniform or varying shape, cross-section, and/or height providing an irregular surface of open pockets or crevices to facilitate the temporary adherence of a food spread to the holder. As shown protrusions 14 and 16 comprise posts which, while dividing the top side into sections to better support the food spread, also serve to extend the time required for an animal to remove all of the contents. Additionally, the tops 18 of the posts may be rounded as shown to allow the food spread to be licked away without injury to an animal's tongue.

The holder may be mounted to a surface in a number of different ways employing, for example, suction cups, or using holes 20 for screws, hooks, and the like. When the back 22 is sufficiently smooth, having for example, a roughness average (Ra) of 0.2-0.4 micrometers, obtained by producing the holder in a highly polished electroplated mold, the holder can be temporarily attached to a supporting smooth surface, like tile or porcelain, by wetting if necessary. An appropriate adhesive may also be used for a more permanent mounting.

A particular advantageous use of the invention has been found to be as a distraction while grooming or bathing a dog. Dogs are known to be difficult to restrain during these activities and placing a holder with a tempting food spread such as peanut butter in the immediate vicinity of the animal can result in a more easily controlled pet while carrying out a grooming or bathing process.

For example, FIG. 5 shows a holder 10 mounted on a curved partially vertical bathtub wall 24.

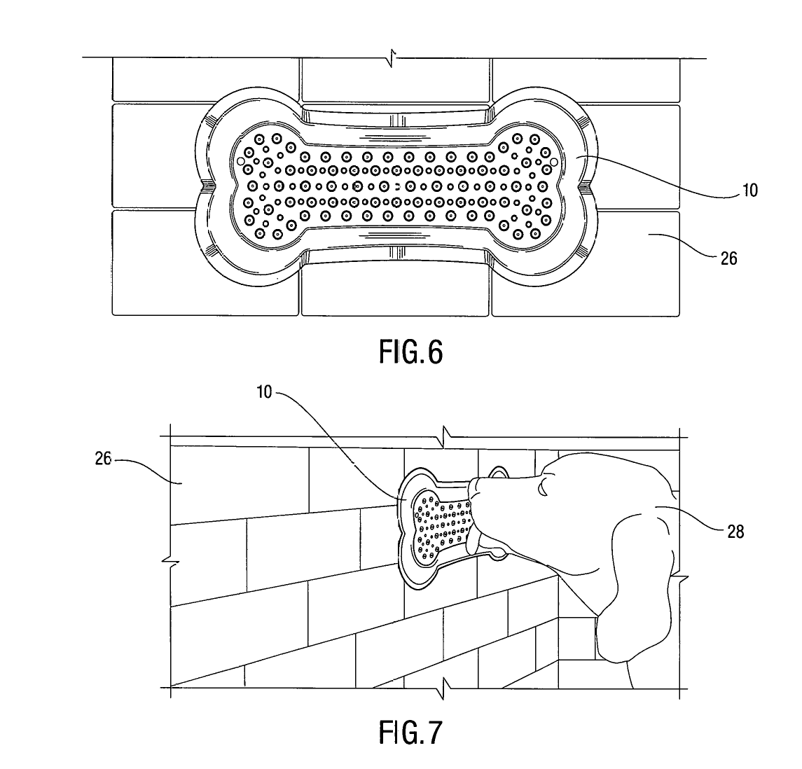

FIG. 6 illustrates a fully vertical position on a tiled surface 26 and FIG. 7, a dog 28 licking a food spread from the surface of the holder.

Accordingly, the scope of the invention described above is hereby defined by the following claims.

What is claimed is:

1. A food spread holder for animals attachable to a surface comprising in combination:
A. a base having a bottom side and a top side, said bottom side adapted to be in contact with, attachable to, and supportable by said surface, said top side configured to retain said food spread when said top side is disposed in a position between a horizontal and vertical orientation, said top side having an irregular surface composed of a plurality of raised members forming an array of pockets and crevices for receiving and holding said food spread.

2. The food spread holder of claim 1 wherein said bottom side is planar.

3. The food spread holder of claim 1 wherein said base is flexible to conform to both planar and curved surfaces.

4. The food spread holder of claim 3 wherein said food spread holder is composed of molded food grade silicon rubber.

5. The food spread holder of claim 1 wherein said raised members comprise a plurality of spaced apart upright protrusions.

6. The food spread holder of claim 5 wherein said upright protrusions comprise posts.

7. The food spread holder of claim 6 wherein said posts are of varying height.

8. The food spread holder of claim 6 wherein said posts have rounded tops.

9. The food spread holder of claim 4 wherein said bottom side has a roughness average (Ra) of between 0.2 and 0.4 micrometers.
